(19) United States
(12) Patent Application Publication
(10) Pub. No.: US 2020/0086469 A1
(43) Pub. Date: Mar. 19, 2020

(54) Universal Pressure Tool for Fastening

(71) Applicant: JBT America, LLC, Menlo Park, CA (US)

(72) Inventor: Bert Friedman, Menlo Park, CA (US)

(21) Appl. No.: 16/618,901

(22) PCT Filed: Jun. 4, 2018
(86) PCT No.: PCT/US2018/035923

§ 371 Date: Dec. 3, 2019

Related U.S. Application Data
(60) Provisional application No. 62/514,862, filed on Jun. 4, 2017.

(51) Int. Cl. B25C 7/00; B25C 1/04; B25C 5/13

(52) U.S. Cl. CPC B25C 7/00; B25C 5/13; B25C 1/047

(57) ABSTRACT

A universal pressure tool for fastening is provided, having changeable barrels, changeable triggers, internal air flow adjustment, laser guide, and changeable magazines.

### BACKGROUND OF THE INVENTION

Construction workers, contractors, and millions of other people use nail guns every day to perform specific tasks. Nail guns are currently designed to support one kind of nail and each time someone has a job to do (flooring, roofing, framing, etc.) they must purchase or rent a different nail gun. Conventional nail guns do not provide an easy way to do any job at hand simply and efficiently. As such, a universal pressure tool for fastening is provided herein.

### SUMMARY OF THE INVENTION

Universal pressure tool for fastening embodiments will provide superior efficiency and usability for a wide range of projects from DIY home improvement to general contracting to professional construction and more.

Universal pressure tool for fastening embodiments are designed to use a typical nail gun layout that users are already familiar with but adapting the current technology to support swappable barrels for a variety of functions and fasteners.

As disclosed herein, universal pressure tool for fastening embodiments proposed may provide faster work, an easy-to-use tool, and variable internal pressure.

Several ways in which the universal pressure tool for fastening embodiments differ from existing nail guns include: swappable barrels for different fastener types, such as flat head nails, checkered flat head nails, countersunk head nails, cupped head nails, diamond point nails, long diamond point nails, blunt point nails, smooth shank nails, barbed shank nails, ringed shank nails, fluked shanked nails, knurled shank nails, flat crown staples, heavy gauge staples, medium gage staples, light gauge staples, round crown staples, wide crown staples, and brads; adjustable the internal pressure for the airline, employ a specialized staple-gun attachment, swappable trigger, custom fastener magazines, and a laser to allow a user to pinpoint exactly where the fastener would be driven into the materials that will be fastened.

One embodiment for a universal pressure tool for fastening can comprise a main body, at least one air chamber section provided in the main body and accumulating therein a compressed air, wherein the compressed air is accumulated to a pressure of 50 psi-150 psi, a solenoid and firing pin chamber, a firing pin reciprocally movably disposed in the cylinder, a head valve provided above the upper open end of the cylinder, the head valve being movable to contact with the upper open end for shutting off a fluid communication between the drive air chamber and the firing chamber for discharging compressed air in the cylinder above the piston to an atmosphere and movable away from the upper open end for providing fluid communication between the firing chamber and the drive air chamber, an exhaust chamber, a head valve chamber section positioned above the head valve, a repetitive valve controlling repetitive movement of the head valve for performing repeated striking operation, a changeable barrel, wherein the changeable barrel comprises at least one type of a fastener magazine and is attached to the universal fastener pressure gun through a port in the housing adapted to engage the changeable barrel, a knob for adjusting internal airflow and the accumulated compressed air required for driving the at least one type of fastener into materials to be fastened together, and a trigger controlling movement of the head valve.

The universal pressure tool for fastening can comprise compressed air that is accumulated to a pressure of 60 psi-120 psi.

The universal pressure tool for fastening can comprise compressed air that is accumulated to a pressure of 100 psi-130 psi.

The universal pressure tool can comprise compressed air is accumulated to a pressure of 90 psi-100 psi.

The universal pressure tool for fastening can comprise at least one fastener is selected from a group consisting of flat head nails, checkered flat head nails, countersunk head nails, cupped head nails, diamond point nails, long diamond point nails, blunt point nails, smooth shank nails, barbed shank nails, ringed shank nails, fluked shanked nails, knurled shank nails, flat crown staples, heavy gauge staples, medium gage staples, light gauge staples, round crown staples, wide crown staples, and brads.

The universal pressure tool can comprise at least one air pressure chamber which has a first air pressure chamber and a second air pressure chamber.

The universal pressure tool for fastening can comprise second air pressure chamber that is adapted to allow adjustment of the compressed air accumulated in the first chamber and adjust the pressure used to drive the at least one fastener into the materials to be fastened together.

Another embodiment can provide for a universal pressure tool for fastening, comprising a main body, at least one air chamber section provided in the main body and accumulating therein a compressed air, wherein the compressed air is accumulated to a pressure of 50 psi-150 psi, a solenoid and firing pin chamber, a firing pin reciprocally movably disposed in the cylinder, a head valve provided above the upper open end of the cylinder, the head valve being movable to contact with the upper open end for shutting off a fluid communication between the drive air chamber and the firing chamber for discharging compressed air in the cylinder above the piston to an atmosphere and movable away from the upper open end for providing fluid communication between the firing chamber and the drive air chamber, an exhaust chamber, a head valve chamber section positioned above the head valve, a repetitive valve controlling repetitive movement of the head valve for performing repeated striking operation, a changeable barrel, wherein the changeable barrel comprises at least one type of a fastener magazine and is attached to the universal fastener pressure gun through a port in the housing adapted to engage the changeable barrel, a knob for adjusting internal airflow and the accumulated compressed air required for driving the at least one type of fastener into materials to be fastened together, and at least one firing mechanism comprising a trigger and a changeable trigger, the trigger controlling movement of the head valve, the changeable trigger controlling movement of the head valve and is adapted to be attached to the universal pressure tool continuously or intermittently, the changeable trigger being detachable from the main housing by a latch, and when attached to the universal pressure tool, bypasses the function of the trigger.

The universal pressure tool for fastening can comprise a trigger that is adapted to drive a nail type fastener and the changeable trigger is adapted to drive a staple type fastener.

The universal pressure tool for fastening can comprise a changeable trigger that disengages the trigger to ensure that only one firing mechanism can be engaged at a time.

The universal pressure tool for fastening can comprise a fastener magazine that is adapted to engage the changeable barrel at an angle of 75 degrees to 100 degrees with respect to the changeable barrel.

The universal pressure tool for fastening can comprise a fastener magazine that is adapted to engage the changeable barrel at an angel of 85 degrees to 95 degrees with respect to the changeable barrel.

The universal pressure tool for fastening can comprise a firing pin that is adapted to drive one fastener from the fastener magazine at a time.

Another embodiment can provide for a universal pressure tool for fastening comprising a main body, at least one air chamber section provided in the main body and accumulating therein a compressed air, wherein the compressed air is accumulated to a pressure of 50 psi-150 psi, a solenoid and firing pin chamber, a firing pin reciprocally movably disposed in the cylinder, a head valve provided above the upper open end of the cylinder, the head valve being movable to contact with the upper open end for shutting off a fluid communication between the drive air chamber and the firing chamber for discharging compressed air in the cylinder above the piston to an atmosphere and movable away from the upper open end for providing fluid communication between the firing chamber and the drive air chamber, an exhaust chamber, a head valve chamber section positioned above the head valve, a repetitive valve controlling repetitive movement of the head valve for performing repeated striking operation, a changeable barrel, wherein the changeable barrel comprises at least one type of a fastener magazine and is attached to the universal fastener pressure gun through a port in the housing adapted to engage the changeable barrel, a knob for adjusting internal airflow and the accumulated compressed air required for driving the at least one type of fastener into materials to be fastened together, and at least one firing mechanism comprising a trigger and a changeable trigger, the trigger controlling movement of the head valve, the changeable trigger controlling movement of the head valve and is adapted to be attached to the universal pressure tool continuously or intermittently, the changeable trigger being detachable from the main housing by a latch, and when attached to the universal pressure tool, bypasses the function of the trigger to ensure that only one fire mechanism, and a laser guide emitting a light beam outwardly of the main housing onto at least one material that will receive the at least one fastener, wherein the light beam identifies the exact location where the universal pressure tool will drive the at least one fastener into the at least one material.

The universal pressure tool for fastening can mark the exact location of where the fastener will be driven into the materials to be fastened by projecting a shaped light beam onto said materials.

The universal pressure tool for fastening can project a shaped light beam that is a straight line.

The universal pressure tool for fastening can project a shaped light beam that is a crosshair.

The universal pressure tool for fastening can project a shaped light beam that is a dot.

The universal pressure tool for fastening can comprise a laser guide that is mounted inside the main housing.

### BRIEF DESCRIPTIONS OF THE DRAWINGS

FIG. 1 is an illustrative representation of an exterior view of a universal pressure tool for fastening in accordance with embodiments of the present invention.

FIG. 2 is an illustrative representation of one internal view of the solenoid chamber that provides part of the driving mechanism for fasteners in accordance with embodiments of the present invention.

FIG. 3 is an illustrative representation of another internal view of the airflow and pressure chamber which provides the other part of the driving mechanism for fasteners in accordance with embodiments of the present invention.

FIG. 4 is an illustrative representation of the custom, changeable barrels for different sized fasteners in accordance with embodiments of the present invention.

FIG. 5 is an illustrative representation of the custom, changeable magazines for different sized fasteners in accordance with embodiments of the present invention.

FIG. 6 is an illustrative representation of the custom, changeable barrel for the staple-gun portion in accordance with embodiments of the present invention.

FIG. 7 is an illustrative representation of the changeable magazine for staples in accordance with embodiments of the present invention.

FIG. 8 is an illustrative representation of the internal mechanism responsible for driving staples with the changeable trigger in accordance with embodiments of the present invention.

### DETAILED DESCRIPTION

The following detailed embodiments presented herein are for illustrative purposes. That is, these detailed embodiments are intended to be exemplary of the present invention for the purposes of providing and aiding a person skilled in the pertinent art to readily understand how to make and use of the present invention.

Accordingly, the detailed discussion herein of one or more embodiments is not intended, nor is to be construed, to limit the metes and bounds of the patent protection afforded the present invention, in which the scope of patent protection is intended to be defined by the claims and equivalents thereof. Therefore, embodiments not specifically addressed herein, such as adaptations, variations, modifications, and equivalent arrangements, should be and are considered to be implicitly disclosed by the illustrative embodiments and claims described herein and therefore fall within the scope of the present invention.

Further, it should be understood that, although steps of various claimed methods may be shown and described as being in a sequence or temporal order, the steps of any such method are not limited to being carried out in any particular sequence or order, absent an indication otherwise. That is, the claimed method steps are considered capable of being carried out in any sequential combination or permutation order while still falling within the scope of the present invention.

Additionally, it is important to note that each term used herein refers to that which a person skilled in the relevant art would understand such term to mean based on the contextual use of such term herein. To the extent that the meaning of a term used herein, as understood by the person skilled in the relevant art based on the contextual use of such term, differs in any way from any particular dictionary definition of such term, it is intended that the meaning of the term as understood by the person skilled in the relevant art should prevail.

Furthermore, a person skilled in the art of reading claimed inventions should understand that “a” and “an” each generally denotes “at least one,” but does not exclude a plurality unless the contextual use dictates otherwise. And that the term “or” denotes “at least one of the items,” but does not exclude a plurality of items of the list.

One electronic nail gun assembly is disclosed in U.S. Pat. No. 4,305,541, hereby incorporated by reference in its entirety. This disclosure provides for an electronically operated portable nail driving gun is disclosed. Nails are driven into a workpiece by a driver blade which is actuated by a solenoid powered by a source of alternating current. Each actuation of the device produces two successive driving strokes delivered to a nail. The tool is also provided with means for preventing more than one nail being driven during each actuation of the tool. A preferred embodiment in which the tool is double insulated is also disclosed as are control circuits which permit operation at either 110 V. or 220 V.

One nailing device adapted for different size nails is disclosed in U.S. Pat. No. 8,205,778, hereby incorporated by reference in its entirety. This disclosure provides for a manually operated nailing device which includes a main body, a striker, an actuator, a resilient member, a nail slot, a magazine, a guider, an adjuster and a controlling means. The magazine has a main rail and a sub rail parallel to the main rail, and the main rail is substantially as tall as the sub rail. The adjuster has a protrusive portion having a guiding surface facing the magazine. The guiding surface is vertically formed with two parallel longitudinal grooves and has a bottom end. The longitudinal grooves extend toward the bottom end. The controlling means is for selectively pushing the adjuster to flush the guiding surface with a step surface of the guider.

One compression type fastening tool having interchangeable components is disclosed in U.S. Pat. No. 3,347,439, herein incorporated by reference in its entirety. This disclosure provides for a manually operated fastener driving tool having an interchangeable fastener magazine and driver blade for accommodation of a diversity of sizes of fasteners.

The disclosures listed above do not disclose a universal pressure tool for fastening comprising swappable barrels for different fastener types, adjustable the internal pressure for the airline, employ a specialized staple-gun attachment, swappable trigger, custom fastener magazines, and/or a laser to allow a user to pinpoint exactly where the fastener would be driven into the materials that will be fastened.

### Changeable Triggers

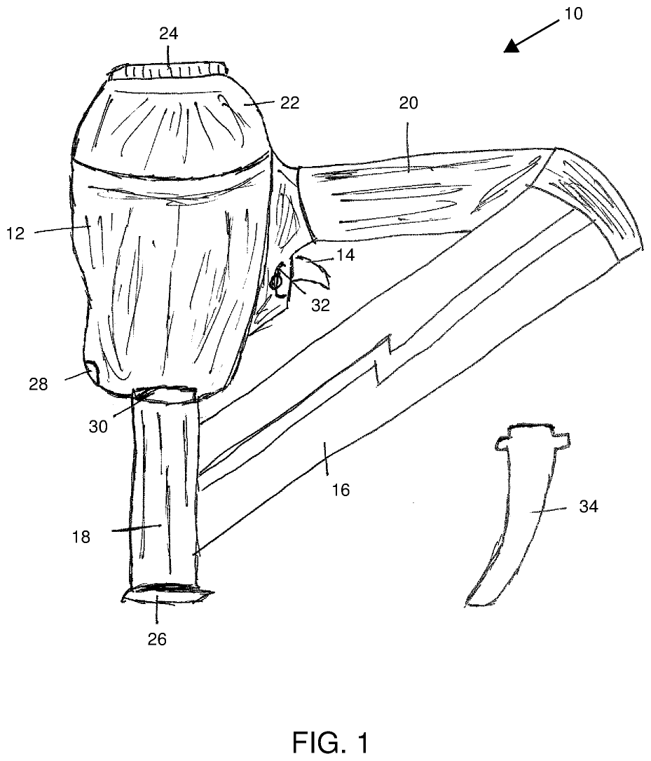

FIG. 1 illustrates one embodiment the universal pressure tool for fastening device 10. One embodiment may comprise a solenoid and firing pin chamber 12, a trigger 14, a fastener magazine 16, a changeable barrel 18, a handle 20, an air chamber and exhaust 22, a pressure knob 24 for adjusting the internal air pressure of the universal pressure tool device 10, a foot/pressure plate 26 for guiding the fasteners into the material(s) to be fastened, a laser guide 28 for accurately locating the point where the fastener will be driven into the materials to be fastened, port to attach a changeable barrel 30, a changeable trigger attachment 32, which can be a staple-gun detachable trigger 34.

The changeable trigger attachment 32 can be a changeable firing mechanism comprising a trigger 14 and a changeable trigger 32. The trigger 14 may always be attached to the universal pressure tool for fastening device 10. A changeable trigger 32 may be included with the embodiments. The changeable trigger 32 may latch into the body of the universal pressure tool for fastening device 10 and bypass the trigger 14 function, rendering the trigger 14 inoperable. This may ensure that only the changeable trigger fire mechanism is active while the changeable trigger 32 is attached.

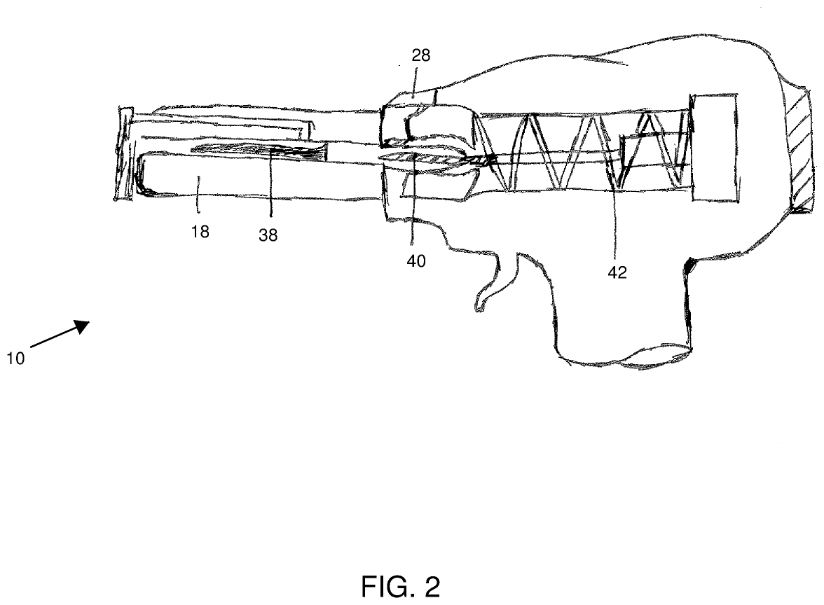

FIG. 2 illustrates an internal view of another embodiment of the universal pressure tool for fastening device 10. A fastener 38 is loaded into a changeable barrel 18 of the universal pressure tool for fastening device 10. A solenoid 42 activates the firing pin 40, and the firing pin 40 mechanically pushes the fastener 38 out of the changeable barrel 18 and into the materials to be fastened. The location of where the universal pressure tool for fastening device 10 will driver the fastener 38 into the materials to be fastened can be marked by a laser 28 that can be mounted internally in the universal pressure tool for fastening device 10.

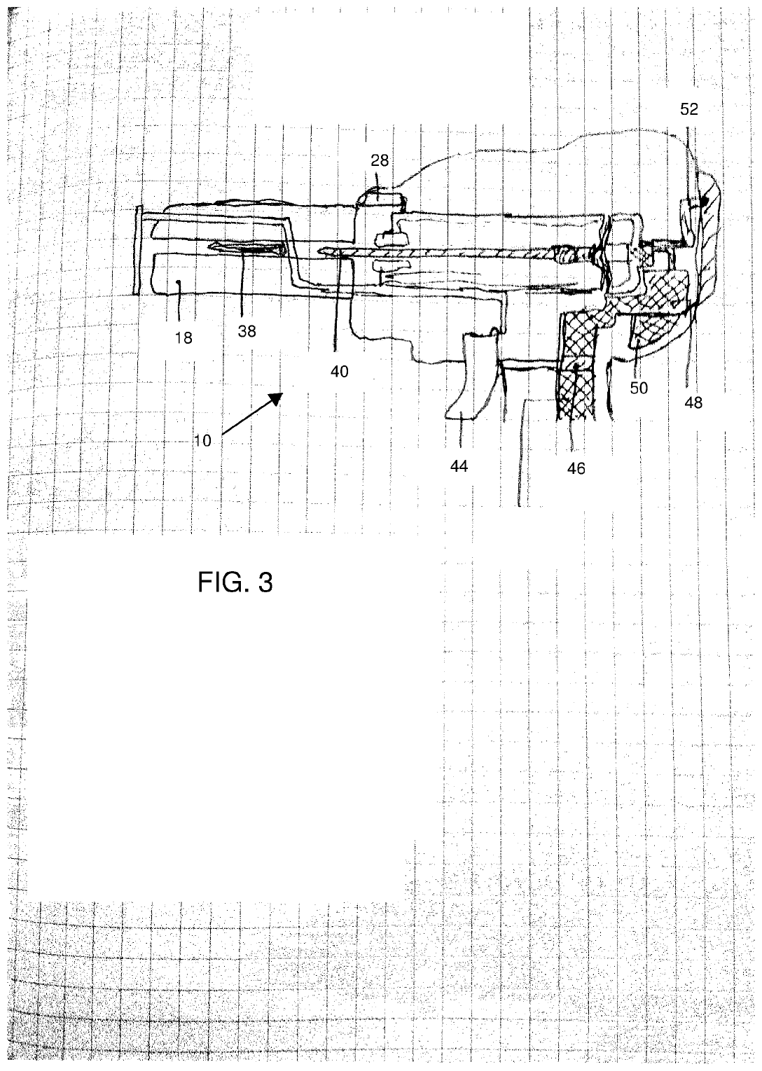

FIG. 3 illustrates another embodiment of the universal pressure tool for fastening device 10, which may include a laser 28 internally mounted to guide the user to the correct spot when driving a fastener 38 or a plurality of fasteners 38 into materials that are to be fastened together. The laser 28 may be configured to show just a dot for guidance or a straight line or a crosshair. Laser guiding may help users line up their fasteners properly and accurately.

### Internal Airflow Adjustment

FIG. 3 also illustrates an internal view of the universal pressure tool for fastening device 10, which may have a pressure knob 24 on the back of the universal pressure tool for fastening device 10 to adjust the internal airflow and control pressure. Air pressure is commonly used as a driving force in modern nail guns. The universal pressure tool for fastening device 10 is connected to an air compressor and uses the directed airflow to help power the firing pin 49. The universal pressure tool for fastening device 10 may comprise first air chamber 48 and a secondary air 50 to adjust the internal pressure. This may allow users to customize the pressure for specific types of fasteners that may require various and different pressures to drive into the materials to be fastened together.

The air from the air compressor enters the first chamber 48 and flows through the universal pressure tool for fastening device 10 through an airflow path 54.

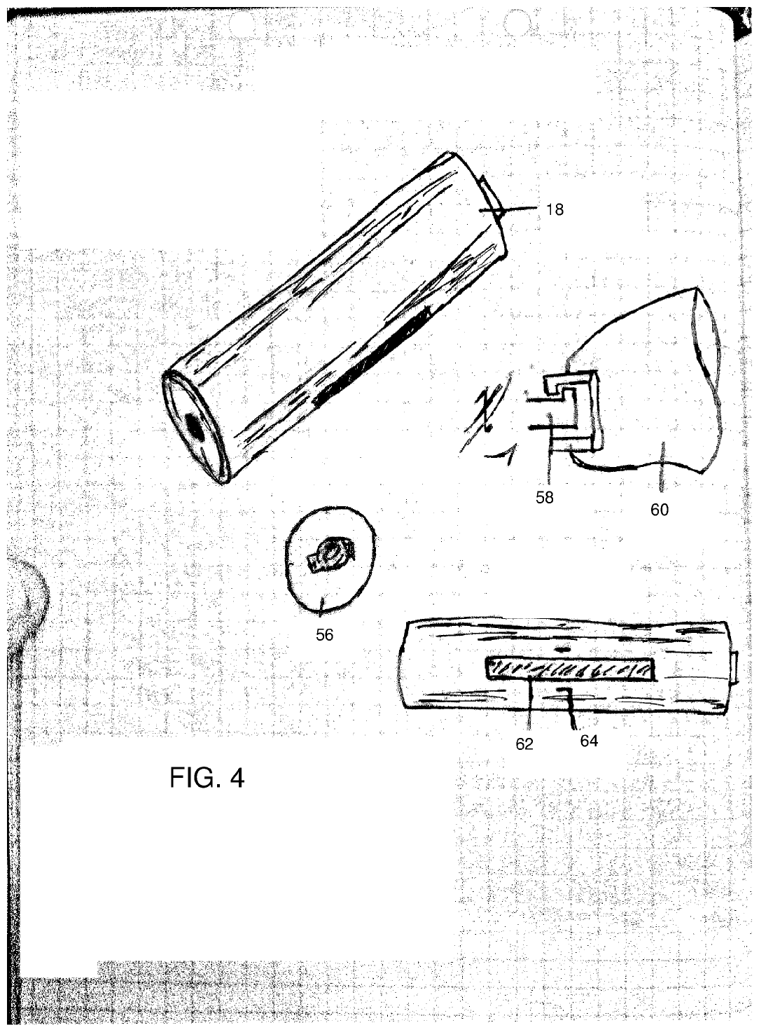

FIG. 4 illustrates one embodiment of the universal pressure tool for fastening, comprising a changeable barrel 18. The changeable barrel 18 can be any shape or design that best accommodates the type of fastener 38 that will be used. FIG. 4 illustrates an embodiment of the back of the changeable barrel 56. The changeable barrel 18 mechanically engages the universal pressure tool for fastening device 10 through a male end latch component with an interlocking groove layout 58 located on the changeable barrel to a female end latch component 60 located on the main body of the universal pressure tool for fastening device 10. The changeable barrel 18 comprises a slot 16 to accommodate delivery of the fasteners 38 from the fastener magazine 16. The magazine 16 mechanically connects to the changeable barrel 18 using a latch 64.

In another embodiment, each changeable barrel 18 may accommodate a specific type of fastener 38 from the magazine 16, such as a framing nail, roofing nail, flooring nail, etc., and attach to the latch 64 on the front of the main body of the universal pressure tool for fastening device 18 by mechanically engaging a male end of a latch comprising an interlocking groove layout 58 with a female end of a latch 60 located on the main body of the universal pressure tool for fastening 10 through port 30. The changeable barrels 18 may work with a firing mechanism that is active at the time and drive in the desired fastener 38 as needed.

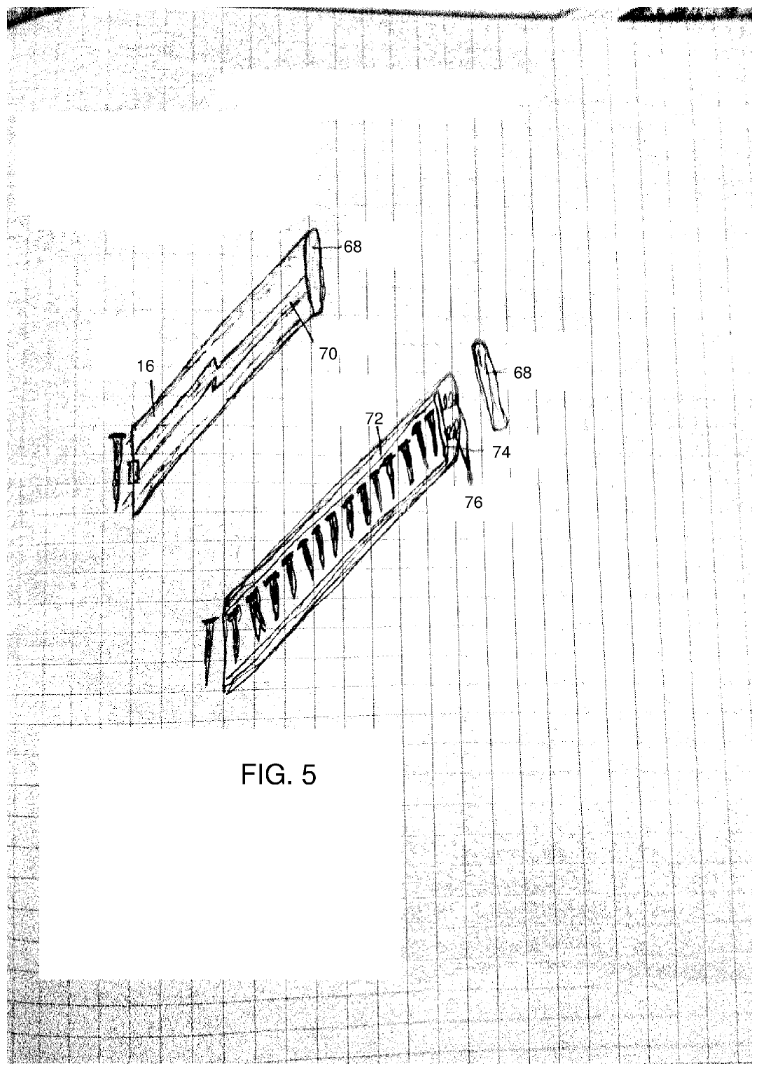

FIG. 5 illustrates another embodiment of the universal pressure tool for fastening device 10, which may include changeable magazines to support different kinds of fasteners, such as nails, staples, and brads. A fastener magazine 16 may comprise a removable back cap 66 to allow for loading or unloading of at least one type of fastener 38, a removable side plate 70, a fastener guidance track 72, a pressure plate 74 and springs 76 to keep the at least one type of fastener 38 under pressure inside the fastener magazine 16 for easy ejection from the fastener magazine 16 when the universal pressure tool device 10 is employed to fasten materials together.

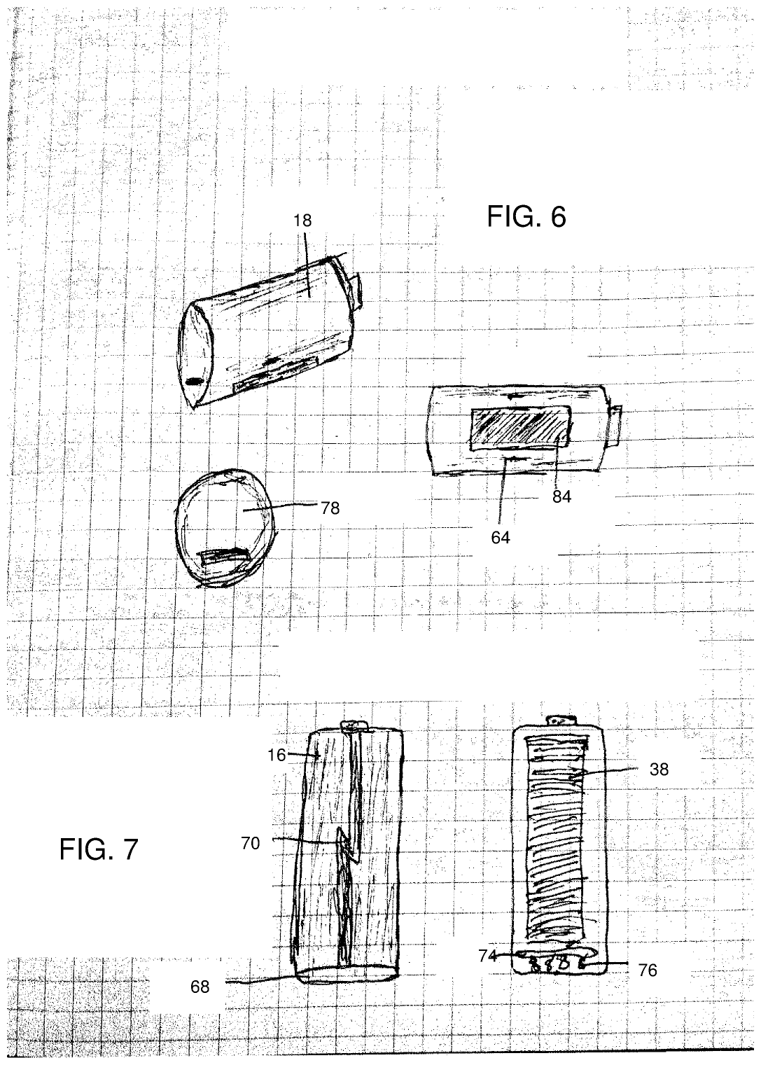

FIG. 6 illustrates another embodiment of the changeable barrel 18. In this embodiment, the changeable barrel 18 can accommodate a specific type of fastener 38, such as a staple. FIG. 6 provides a front view 78 of the changeable barrel 18 that is adapted to receive staples. The staples can be loaded in a fastener magazine 16 that is configured to accommodate staples, and the fastener magazine 16 engages the universal pressure tool for fastening device using a magazine latch 64 and staple load slot 80.

FIG. 7 illustrates another embodiment of a magazine 16. The magazine 16 may mechanically connect to the universal pressure tool device 10 at an angle that best suits the unobstructed flow of the fastener 38 from the fastener magazine 16 into the changeable barrel 18. As an example, if the fastener 38 is a staple, the fastener magazine 16 may sit at an angle between 75 degrees and 100 degrees to the changeable barrel 18. The fastener magazine 16 may sit at an angle between 80 degrees and 95 degrees to the changeable barrel 18. The fastener magazine 16 may sit at an angle between 85 degrees and 90 degrees to the changeable barrel 18. The angle can be chosen by the user to provide accurate staple replacement to the changeable barrel 18 as each staple is pressed into the universal pressure tool device 10. In some embodiments, the fastener magazine 16 may have at least one latch on the top to attach to the changeable barrel 18 and secure its positioning in rough environments, as well as to ensure that the spring-loaded fasteners flow into the changeable barrel 18 correctly, without jamming.

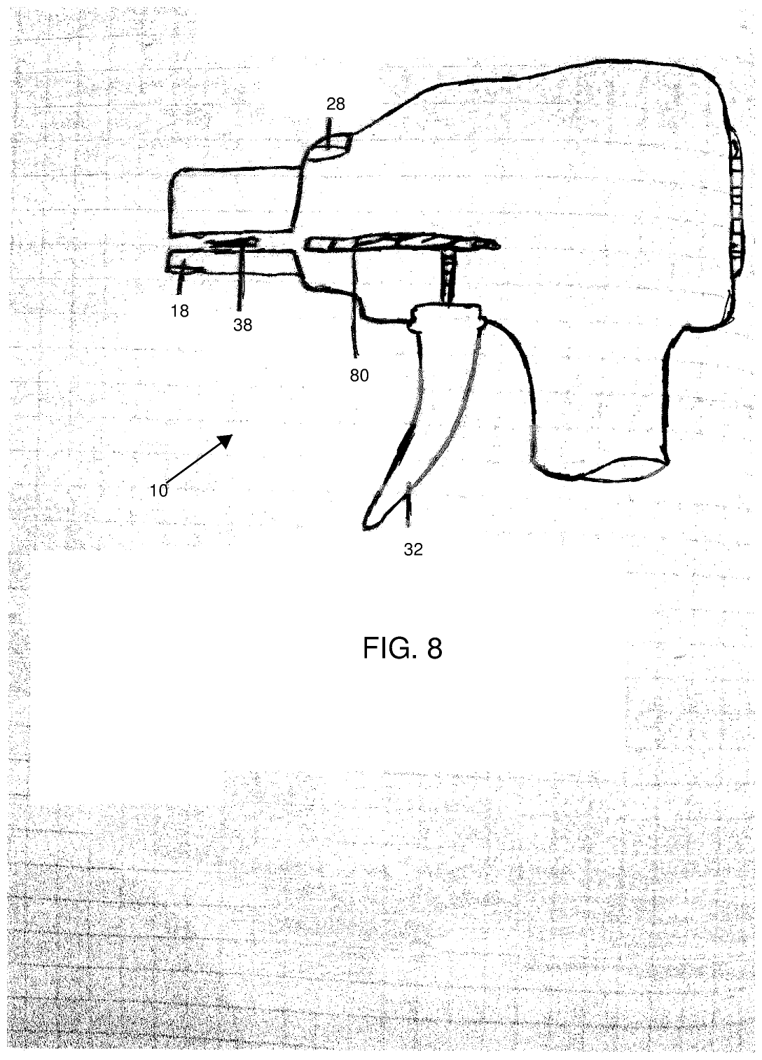

FIG. 8 illustrates another embodiment of the universal pressure tool for fastening device 10. The changeable barrel 18 is adapted to accommodate a type of fastener 38, such as staples. The changeable trigger attachment 32 can be a changeable firing mechanism comprising a trigger 14 and a changeable trigger 32. The trigger 14 may always be attached to the universal pressure tool for fastening device 10. A changeable trigger 32 may be included with the embodiments. The changeable trigger 32 may be adapted to dispense staples by employing a second firing pin 80 that is fired by solenoid 12. The solenoid 12 may be activated using a different air pressure than would be used for deploying nail type fastener 38.

The air pressure used to deploy different types of fasteners 38 from universal pressure tool for fastening device can be controlled. Deploying different types of fasteners 38 requires different air pressures. For instance, deploying framing nails will require the most air pressure because these nails are typically 3 to 3½-inch nails that are driven into framing studs during the construction process of rough framing. Typical air pressures for this application range between 130 psi (pounds per square inch) and 100 psi. Deploying a finishing nail, which is a thin brad-type nail that is typically ¾-inch to 2½-inches in length, having two typical gauges of diameter, 16 and 18 gauge, will require a different air pressure than deploying a framing nail. The 18 gauge finishing nails are thinner and work better for intricate moldings, while 16 gauge nails are thicker and stronger and good for typical window, door and base trim applications. These nails do not typically have a head and they create a very small hole that can easily be filled with wood putty and be unnoticeable. The pressure required for deploying a 16 gauge finishing nail will range from 120 psi to 60 psi, depending on the material the finishing nail is driven into. Harder woods, like maple, will require a higher pressure than pine, which is a much softer wood.

Deploying a roofing nail or “coil nail” (nails that go into the universal pressure tool for fastening device 10), which come in coils and are inserted into a round housing, require a different air pressure to deploy them than a finishing nail or a framing nail. The roofing nails can be fed into the universal pressure tool for fastening device 10 like a belt, which prevents jamming while in use. Roofing nail are typically 1¼ to 2½-inches long, made of galvanized steel, and fasten asphalt composite shingles to a roof. The air pressure used for deploying roofing nails is typically 100 psi to 90 psi. Burying the roofing nail too deep or not deep enough can affect the life of the roof, so it is very important to dial the pressure in correctly.

As to the manner of usage and operation of the present invention, the same should be apparent from the above description. Accordingly, no further discussion relating to the manner of usage and operation will be provided.

While a preferred embodiment of the system has been described in detail, it should be apparent that modifications and variations thereto are possible, all of which fall within the true spirit and scope of the invention. With respect to the above description then, it is to be realized that the optimum dimensional relationships for the parts of the invention, to include variations in size, materials, shape, form, function and manner of operation, assembly and use, are deemed readily apparent to one skilled in the art, and all equivalent relationships to those illustrated in the drawings and described in the specification are intended to be encompassed by the present invention.

Throughout this specification, unless the context requires otherwise, the word “comprise” or variations such as “comprises” or “comprising” or the term “includes” or variations, thereof, or the term “having” or variations thereof will be understood to imply the inclusion of a stated element or integer or group of elements or integers but not the exclusion of any other element or integer or group of elements or integers. In this regard, in construing the claim scope, an embodiment where one or more features is added to any of the claims is to be regarded as within the scope of the invention given that the essential features of the invention as claimed are included in such an embodiment.

Those skilled in the art will appreciate that the invention described herein is susceptible to variations and modifications other than those specifically described. It is to be understood that the invention includes all such variations and modifications that fall within its spirit and scope. The invention also includes all of the steps, features, compositions and compounds referred to or indicated in this specification, individually or collectively, and any and all combinations of any two or more of said steps or features.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A universal pressure tool for fastening, comprising:
a main body;
at least one air chamber section provided in the main body and accumulating therein a compressed air, wherein the compressed air is accumulated to a pressure of between about 50 psi-150 psi;
a solenoid and firing pin chamber;
a firing pin reciprocally movably disposed in the cylinder;
a head valve provided above the upper open end of the cylinder, the head valve being movable to contact with the upper open end for shutting off a fluid communication between the drive air chamber and the firing chamber for discharging compressed air in the cylinder above the piston to an atmosphere and movable away from the upper open end for providing fluid communication between the firing chamber and the drive air chamber;
an exhaust chamber;
a head valve chamber section positioned above the head valve;
a repetitive valve controlling repetitive movement of the head valve for performing repeated striking operation;
a changeable barrel, wherein the changeable barrel comprises at least one type of a fastener magazine and is attached to the universal fastener pressure gun through a port in the housing adapted to engage the changeable barrel;
a knob for adjusting internal airflow and the accumulated compressed air required for driving the at least one type of fastener into materials to be fastened together; and
a trigger controlling movement of the head valve.

2. The universal pressure tool for fastening of claim 1, wherein the compressed air is accumulated to a pressure of between about 60 psi-120 psi.

3. The universal pressure tool for fastening of claim 1, wherein the compressed air is accumulated to a pressure of between about 100 psi-130 psi.

4. The universal pressure tool for fastening of claim 1, wherein the compressed air is accumulated to a pressure of between about 90 psi-100 psi.

5. The universal pressure tool for fastening of claim 1, wherein the at least one fastener is selected from a group consisting of flat head nails, checkered flat head nails, countersunk head nails, cupped head nails, diamond point nails, long diamond point nails, blunt point nails, smooth shank nails, barbed shank nails, ringed shank nails, fluked shanked nails, knurled shank nails, flat crown staples, heavy gauge staples, medium gage staples, light gauge staples, round crown staples, wide crown staples, and brads.

6. The universal pressure tool for fastening of claim 1, wherein the at least one air pressure chamber comprises a first air pressure chamber and a second air pressure chamber.

7. The universal pressure tool for fastening of claim 6, wherein the second air pressure chamber is adapted to allow adjustment of the compressed air accumulated in the first chamber and adjust the pressure used to drive the at least one fastener into the materials to be fastened together.

8. A universal pressure tool for fastening, comprising:
a main body;
at least one air chamber section provided in the main body and accumulating therein a compressed air, wherein the compressed air is accumulated to a pressure of between about 50 psi-150 psi;
a solenoid and firing pin chamber;
a firing pin reciprocally movably disposed in the cylinder;
a head valve provided above the upper open end of the cylinder, the head valve being movable to contact with the upper open end for shutting off a fluid communication between the drive air chamber and the firing chamber for discharging compressed air in the cylinder above the piston to an atmosphere and movable away from the upper open end for providing fluid communication between the firing chamber and the drive air chamber;
an exhaust chamber;
a head valve chamber section positioned above the head valve;
a repetitive valve controlling repetitive movement of the head valve for performing repeated striking operation;
a changeable barrel, wherein the changeable barrel comprises at least one type of a fastener magazine and is attached to the universal fastener pressure gun through a port in the housing adapted to engage the changeable barrel;
a knob for adjusting internal airflow and the accumulated compressed air required for driving the at least one type of fastener into materials to be fastened together; and
at least one firing mechanism comprising a trigger and a changeable trigger;
the trigger controlling movement of the head valve;
the changeable trigger controlling movement of the head valve and is adapted to be attached to the universal pressure tool continuously or intermittently, the changeable trigger being detachable from the main housing by a latch, and when attached to the universal pressure tool, bypasses the function of the trigger.

9. The universal pressure tool for fastening of claim 8, wherein the at least one fastener is selected from a group consisting of flat head nails, checkered flat head nails, countersunk head nails, cupped head nails, diamond point nails, long diamond point nails, blunt point nails, smooth shank nails, barbed shank nails, ringed shank nails, fluked shanked nails, knurled shank nails, flat crown staples, heavy gauge staples, medium gage staples, light gauge staples, round crown staples, wide crown staples, and brads.

10. The universal pressure tool for fastening of claim 9, wherein the trigger is adapted to drive a nail type fastener and the changeable trigger is adapted to drive a staple type fastener.

11. The universal pressure tool for fastening of claim 10, wherein attaching the changeable trigger disengages the trigger to ensure that only one firing mechanism can be engaged at a time.

12. The universal pressure tool for fastening of claim 9, wherein the fastener magazine is adapted to engage the changeable barrel at an angle of 75 degrees to 100 degrees with respect to the changeable barrel.

13. The universal pressure tool for fastening of claim 9, wherein the fastener magazine is adapted to engage the changeable barrel at an angel of 85 degrees to 95 degrees with respect to the changeable barrel.

14. The universal pressure tool for fastening of claim 9, wherein the firing pin is adapted to drive one fastener from the fastener magazine at a time.

15. A universal pressure tool for fastening, comprising:
a main body;
at least one air chamber section provided in the main body and accumulating therein a compressed air, wherein the compressed air is accumulated to a pressure of between about 50 psi-150 psi;
a solenoid and firing pin chamber;
a firing pin reciprocally movably disposed in the cylinder;
a head valve provided above the upper open end of the cylinder, the head valve being movable to contact with the upper open end for shutting off a fluid communication between the drive air chamber and the firing chamber for discharging compressed air in the cylinder above the piston to an atmosphere and movable away from the upper open end for providing fluid communication between the firing chamber and the drive air chamber;
an exhaust chamber;
a head valve chamber section positioned above the head valve;
a repetitive valve controlling repetitive movement of the head valve for performing repeated striking operation;
a changeable barrel, wherein the changeable barrel comprises at least one type of a fastener magazine and is attached to the universal fastener pressure gun through a port in the housing adapted to engage the changeable barrel;
a knob for adjusting internal airflow and the accumulated compressed air required for driving the at least one type of fastener into materials to be fastened together; and
at least one firing mechanism comprising a trigger and a changeable trigger;
the trigger controlling movement of the head valve;
the changeable trigger controlling movement of the head valve and is adapted to be attached to the universal pressure tool continuously or intermittently, the changeable trigger being detachable from the main housing by a latch, and when attached to the universal pressure tool, bypasses the function of the trigger to ensure that only one fire mechanism; and
a laser guide emitting a light beam outwardly of the main housing onto at least one material that will receive the at least one fastener, wherein the light beam identifies the exact location where the universal pressure tool will drive the at least one fastener into the at least one material.

16. The universal pressure tool for fastening of claim 15, wherein the exact location is marked by a shaped light beam.

17. The universal pressure tool for fastening of claim 16, wherein the shaped light beam is a straight line.

18. The universal pressure tool for fastening of claim 16, wherein the shaped light beam is a crosshair.

19. The universal pressure tool for fastening of claim 16, wherein the shaped light beam is a dot.

20. The universal pressure tool for fastening of claim 15, wherein the laser guide is mounted inside the main housing.
